(19) United States
(12) Patent Application Publication
(10) Pub. No.: US 2009/0100134 A1
(43) Pub. Date: Apr. 16, 2009

(54) System and Method for Customized Sharing of Multimedia Content in a Communications Network

(75) Inventor: Goran Svennarp, Lund (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/871,332

(22) Filed: Oct. 12, 2007

(51) Int. Cl. G06F 15/16

(52) U.S. Cl. 709/204

(57) ABSTRACT

Methods and devices for sharing multimedia content in a communications network are disclosed. In an exemplary method, the initiation of a communications session between a first communications device and a second communications device is detected. In response, a content update, based on multimedia content stored on the first communications device, is formed and sent to the second communications device. In some embodiments, the content update is formed using files stored on the first communications device. In other embodiments, the content update describes one or more files stored on the first communications device, and may comprise pointers to the files, such as URLs, for use by the second communications device in retrieving one or more of the files.

### BACKGROUND OF THE INVENTION

The present invention relates generally to communication systems and more particularly to methods and devices for sharing multimedia content between participants in a communications session.

Modern communication devices are increasingly likely to support a variety of applications in addition to a variety of communications modes. Mobile telephones, for example, commonly include video/still cameras and music players, and support e-mail, instant messaging, text messaging, picture messaging, online chat, and various other applications, as well as providing conventional telephone functionality.

These multi-mode devices, then, increasingly serve as portable databases, containing digital images, video files, music files, and the like. In some cases, these files are very personal, in the sense that they reflect the device owner's tastes, style, interests, and personal relationships. As a result, these files are frequently shared between friends. In other instances, these files may be business oriented, in which case the files may need to be shared between colleagues. In either case, one or more of the files may actually be the subject of a phone call or other communications session between the friends or colleagues. In these cases, it would be convenient if the discussed files were readily available to both parties.

With many communication devices, multimedia files may easily be shared with others, whether by attaching one or more files to an e-mail message, or by posting one or more files to a server. However, keeping track of which files have been shared with which users is difficult. Mass mailing of a large group of files to a large group of friends or colleagues is one approach for ensuring that everyone in a user's social network is “up-to-date,” but this approach is not well suited for individualized sharing according to the recipient's tastes, interests, or personal connections to the device user. Accordingly, improved methods for sharing multimedia files between users of a communication network are needed.

### SUMMARY

The present invention provides methods and devices for sharing multimedia content in a communications network. In an exemplary method, the initiation of a communications session between a first communications device and a second communications device is detected. In response, a content update, based on multimedia content stored on the first communications device, is formed and sent to the second communications device. In some embodiments, the content update is formed using files stored on the first communications device. In other embodiments, the content update describes one or more files stored on the first communications device, and may comprise pointers to the files, such as URLs, for use by the second communications device in retrieving one or more of the files.

In one or more embodiments, the initiation of the communications session is detected at the first communications device, and the content update is formed by the first communications device. In other embodiments, the initiation of the communications session is detected at a server, and the content update is formed by the server and sent to the second communications device.

In several embodiments, the content update is formed based on a prior content update previously sent to the second communications device. In some embodiments, the content update is formed based on a content profile corresponding to the user of the second communications device. In these embodiments, a method for sharing multimedia content may further comprise retrieving the content profile, whether from a server, from the second communications device, or from local memory at the first communications device. The content update may comprise copies of one more files stored on the first communications device, descriptions of one or more files stored on the first communications device, or both. The content update may comprise pointers, such as Uniform Resource Locators (URLs) for use in retrieving copies of files stored on the first communications device, either from the first communications device itself or from a separate server.

### BRIEF DESCRIPTION OF THE DRAWINGS

FIG. 1 illustrates an exemplary communication network.

FIG. 2 is a flow diagram illustrating an exemplary method for sharing multimedia content.

FIG. 3 illustrates a content profile according to one or more embodiments of the invention.

FIG. 4 illustrates another exemplary signal flow.

FIG. 5 is a block diagram illustrating functional components of an exemplary communications device.

FIG. 6 is a block diagram illustrating functional components of an exemplary server.

### DETAILED DESCRIPTION

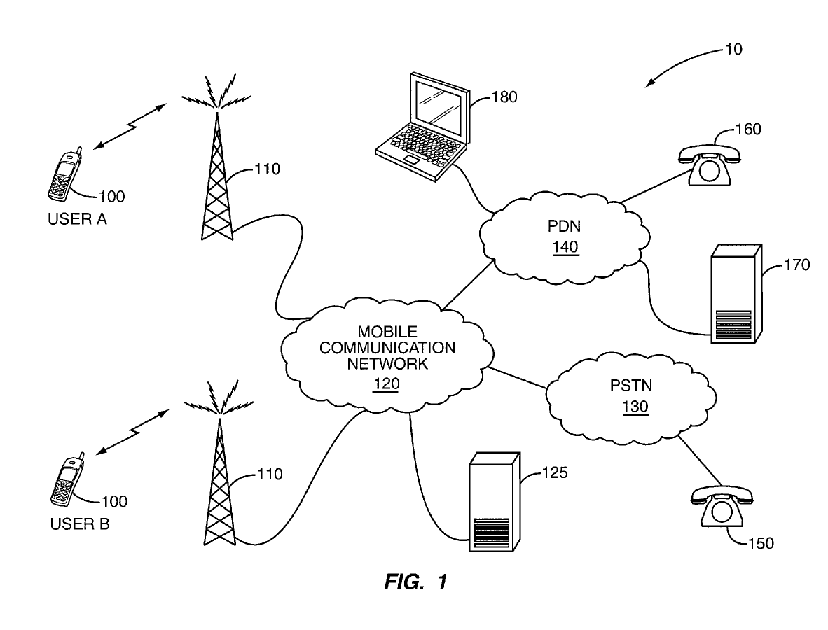

Referring now to the drawings, the present invention will be described in the context of a communication network 10 as shown in FIG. 1. Communication network 10 comprises a mobile communication network 120 having one or more base stations or wireless access points 110 for communicating with mobile terminals 100. Mobile terminals 100 may comprise, for example, cellular telephones, personal digital assistants, laptop computers, or other mobile devices. Mobile communication network 120 connects to the public switched telephone network (PSTN) 130 and to a packet data network (PDN) 140. PSTN 130 is a circuit-switched network providing both voice and data communications, and in particular provides voice service to traditional telephones such as telephone 150. PDN 140 comprises a packet-switched network that implements known protocols, such as conventional Internet protocols, for routing packets of data from one end point to another. PDN 140 may comprise a public or private network, and may be a wide area network, a local area network, or a combination of both. The Internet is one well-known example of a PDN 140. Among the services that may be provided using PDN 140 are packet-switched voice services, such as so-called Voice-over-Internet-Protocol, or VoIP, services. Using VoIP technology, digital devices such as Internet phone 160 or computer 180 may conduct voice calls with other VoIP devices or with traditional phones such as telephone 150.

One or more content servers 170 connect to the packet data network 140. Content servers 170 are accessible to the mobile terminals 100 via the mobile communication network 120 and packet data network 140. Content servers 170 are also available to digital phone 160 and computer 180, as well as to other digital devices (not shown), via PDN 140. The content servers 170 may, for example, comprise web servers, email servers, file servers, or other types of servers. One or more network application servers 125 are connected to the mobile communication network 120, and are typically used by wireless service providers to provide data services to mobile terminals 100. These network application servers 125 may or may not be accessible to users outside the mobile communication network 120, such as through PDN 140.

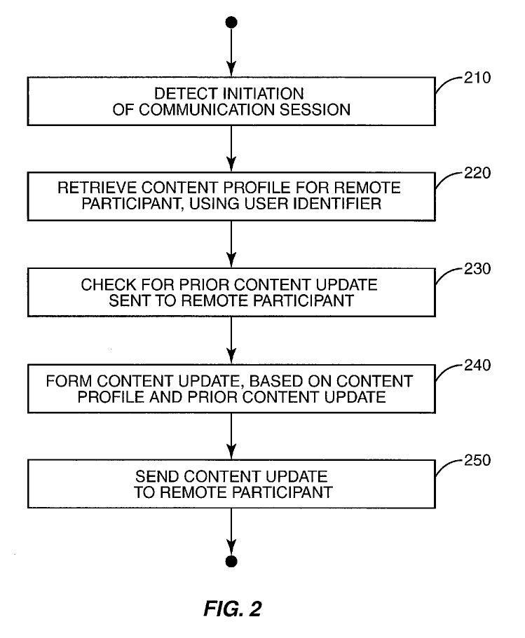

FIG. 2 illustrates a general method for sharing content, such as multimedia content, in association with a communications session. Although the method illustrated in FIG. 2 is described below with reference to the system components of FIG. 1, those skilled in the art will recognize that the described method is applicable to a variety of systems and network topologies. Furthermore, while the method of FIG. 2 is discussed below as it might be implemented on an end user device, such as a mobile terminal 100, those skilled in the art will appreciate that the various elements of FIG. 2 might be implemented at other system nodes. Indeed, the elements of the method illustrated in FIG. 2 might not all be implemented at the same system node.

The method of FIG. 2 begins with the initiation of a communication session, such as a voice or video call between User A and User B on mobile terminals 100. This initiation is “detected” at block 210. In several embodiments, the method of FIG. 2 may be implemented at on of the end user terminals, e.g., a mobile terminal 100. In such embodiments, detecting the initiation of a communication session may simply comprise receiving a notification of an incoming call, or detecting the initiation by a user of an outgoing call. Similarly, the initiation of a instant messaging session may be detected by receiving notification of an incoming message, or by detecting that the user of mobile terminal 100 has selected an electronic identifier for the purpose of beginning a new instant messaging session.

Typically, the identity of the remote participant is known or readily determined when the communication session is initiated. For instance, an incoming call notification is often accompanied by calling line identification (CLI) data that identifies the calling terminal. In some cases, a calling party name may also be supplied; in other cases, a calling party name may be retrieved from a locally stored database, using the CLI data. In the case of an outgoing call, of course, the identity of the remote participant typically corresponds to the dialed number. Similarly, incoming and outgoing instant messages or e-mails are associated with identifiers corresponding to the remote party.

Accordingly, upon detection of a new communication session, a content profile corresponding to the remote participant is retrieved at block 220, using a user identifier for the remote participant. This user identifier may be the identifier received in association with an incoming communication from the remote party, or an identifier used to address an outgoing communication to the remote party. Alternatively, this user identifier may be an identifier retrieved from a locally stored contacts database, using an identifier more directly associated with the communication. This latter approach may be preferred when a single user is associated with several communications addresses, e.g. multiple phone numbers, e-mail addresses, and the like. Any one of these communications addresses may be used to index or search a contacts database to retrieve a user identifier for purposes of content sharing.

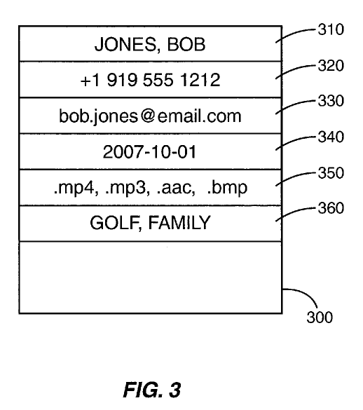

Several content profiles, corresponding to several friends, colleagues, or other correspondents, may be stored in a user's mobile terminal 100. These content profiles, which may be individually customized, may each contain one or several parameters indicating file types or other categories of content that are to be shared with the corresponding party. An exemplary content profile 300 is illustrated in FIG. 3. Content profile 300 is a data record that may be stored in a user terminal, such as mobile terminal 100, or stored in a content server 170 or network application server 125. The exemplary content profile 300 of FIG. 3 comprises a user identifier 310, a first communications identifier 320, and a second communications identifier 330. The first and second communications identifiers 320 and 330 comprise a phone number and e-mail address respectively. Content profile 300 also includes a date field 340, which indicates when the most recent content update was provided to the user identified by user identifier 310. This date field 340 may be used to avoid sending unnecessary, i.e., duplicative, content updates to frequent correspondents, for example, or may be used to determine which content has changed since the last content update was sent to this participant.

Content profile 300 further comprises a file types field 350, which may include several parameters indicating which of several possible file types should be considered when sharing content with this particular correspondent. In FIG. 3, content profile 300 includes parameters indicating that certain video files, music files, and image files should be considered in connection with Bob Jones. These file type parameters might in some embodiments be selected from a list of allowable file types; file extensions (e.g., “.mp3”, “.mp4”, “.bmp”) are convenient parameters for this purpose. Other file types may be included, of course, such as e-mail messages, SMS or MMS messages, instant message transcripts, word processing files, spreadsheets, and so on.

Similarly, categories field 360 includes parameters indicating subjects, categories, or interests that should be considered in forming a content update for the remote correspondent. As with the file type parameters of field 350, these parameters might be selected from a list of allowed subject parameters. Alternatively, these parameters may be user-defined “keywords.” In either case, these parameters may be used in searching the host communications device for related content. In the exemplary content profile 300 of FIG. 3, subject parameters 360 include “GOLF” and “FAMILY.” These parameters may be used to determine which content should be shared with the remote party (Bob Jones, in this example). The parameters may correspond to file directories, for example, or may correspond to metadata “tags” associated with one or more individual files. Thus, the presence of the parameter “GOLF” in subject parameter field 360 may result in all files under the subdirectory “GOLF PICTURES” to be shared with Bob Jones, or may result in all files having a metadata tag of “GOLF” to be shared, or both.

Referring back to FIG. 2, a content profile 300 is retrieved at block 220 as discussed above. Although in many instances a personalized content profile 300 corresponding to the remote party will be available, in other instances one will not. In these instances, a generic content profile may be used instead, or the method may be aborted with respect to this particular remote party. In some embodiments, the response of mobile terminal 100 to the lack of a personalized content profile 300 may be configured by the user in a configuration setting.

In some cases, one or more content profiles 300 may correspond to a group of correspondents, rather than an individual. Thus, retrieving a content profile using a user identifier for one of these correspondents may require the retrieval of a group identifier associated with the user identifier, followed by retrieval of the content profile using the group identifier. Those skilled in the art will appreciate that various approaches for sorting individuals into groups, and retrieving files or data objects associated with those groups, are possible. In some embodiments, these group associations may be integrated into a contacts database, or electronic “phonebook”, stored in the communications terminal or accessible by a network connection.

At block 230, mobile terminal 100 checks whether a prior content update was sent to the party (or device) corresponding to the user identifier. In some embodiments, this may be performed by simply retrieving the date stored in the date field 340 of the content profile 300; the presence of a valid date may indicate that a prior content update was sent, as well as the date on which it was sent. If a prior content update was sent, the contents of that prior content update may be retrieved, in some embodiments. The prior content update may thus be analyzed to determine which content was previously shared with the remote party. In some cases, this may be performed using the date on which the prior content update was sent. In these embodiments, only content bearing a date after that date might be considered in forming the new content update. In other embodiments, the actual content of one or more prior content updates is analyzed to determine which files were previously shared, and which should be considered in forming a new content update.

Accordingly, a content update is formed at block 240, based on the content profile retrieved at block 220, and the prior content update, if any, found at block 230. This content update is sent to the remote party at block 250, using any available data channel. In some instances, the content update may be sent as part of the communications session, such as an attachment to an e-mail or instant message, while in others, the content update is sent by alternative means. In some cases, the content update may be addressed using an identifier other than the one associated with the initially detected communications session. For instance, the method of FIG. 2 may be triggered by a voice call, in which case the remote party may be identified by a phone number. The corresponding content update, however, might be sent to an e-mail address associated with the remote party. The e-mail address in this example might be retrieved from a contacts database, or from the content profile 300 corresponding to the remote party.

As noted above, the contents of the content update formed at block 240 may be customized according to a personalized content profile 300. Alternatively, the content update may be formed according to a generic profile that indicates which file types and/or file categories should be shared with the remote party. In addition, the content update may be further adapted according to a prior content update sent to the remote party, as discussed above. In some embodiments, the content update is further adapted according to an operating status or operating mode of the remote party. For instance, if the location of the remote party is known or determined, the content update may be adapted according to that location. In some instances, the location information may be used as a parameter in determining which subject matter is appropriate for sharing. In others, the location information may be used to determine which file types, or file sizes, are appropriate for sharing. For example, different file types may be sent depending on whether the remote party is at or near his home, or is traveling. In some embodiments, the content profile 300 may include parameters identifying file types and/or subjects that should be selectively updated depending on the remote party's location.

Similarly, the content update may be adapted according to a communications mode. For example, a voice call from a particular remote party may trigger a different content update than the initiation of an instant messaging session with that same party. This adaptation may be accomplished by determining the operating mode and using a different content profile 300 for each communication mode, or may alternatively be accomplished by specifying file types and/or subject matters to be shared according to operating mode, in a single content profile 300.

The content update sent to the remote party at block 250 may comprise copies of one or more files stored on the mobile terminal 100. However, in many instances, this approach might result in excessively large file transfers. Accordingly, the content update may instead include descriptions of the relevant files, rather than copies of the files. In some embodiments, these descriptions may include pointers, or hyperlinks, that permit the recipient to access the file or a copy of the file. For example, the content update may include one or more Uniform Resource Locators (URLs). These pointers may be formed so that a recipient can retrieve the corresponding file directly from the end user terminal that sent the content update. Alternatively, a pointer may direct a recipient to a content server 170, accessible via the Internet, or application server 125, accessible via mobile communication network 120, for retrieval of a copy of the applicable file.

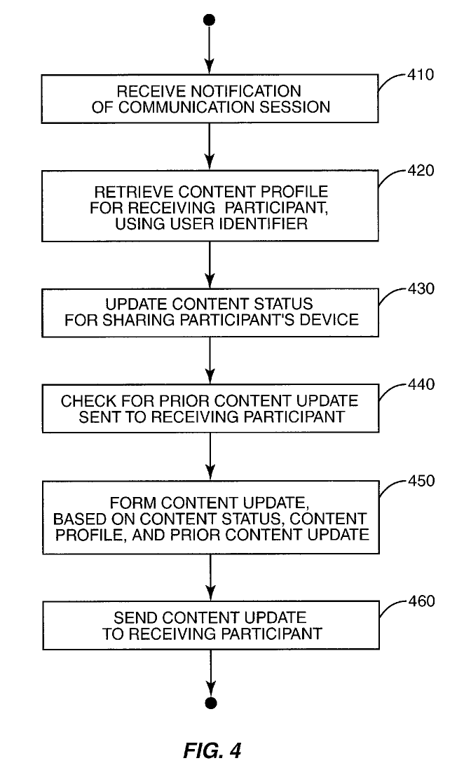

FIG. 4 illustrates another exemplary method for sharing multimedia content. Whereas the flow diagram of FIG. 2 was discussed as though it was implemented on an end user terminal, such as mobile terminal 100, the flow of FIG. 4 will be discussed with reference to its implementation on a content server 170 or application server 125. Those skilled in the art will recognize, however, that one or more of the steps illustrated in FIG. 4 might be implemented at another node or nodes in a communications system.

The flow of FIG. 4 begins with the receipt of a notification of a communication session, at block 410. This notification may have originated at a node in mobile communication network 120, PSTN 130, or PDN 140, or may have originated at either one of the end user terminals, such as User A's mobile terminal 100. The notification typically identifies both of the participants in a communications session. In some instances, the notification may identify three or more participants, such as in the event of a conference call, multi-party chat session, or the like. Thus, the notification will identify a first party (or a device associated with the first party) that wishes to share one or more files stored on his device as well as one or more parties with whom the files are to be shared. For convenience, the following discussion will refer to the first party as the “sharing” party and any of the other parties as “receiving” parties.

At block 420, a content profile 300 corresponding to one or more of the receiving parties is retrieved. In some embodiments, the content profile 300 may be stored in a database on content server 170 (or application server 125) or otherwise immediately accessible to content server 170. In other embodiments, content server 170 (or applications server 125) may request the content profile 300 from the sharing party's device or from the receiving party's device. In still other embodiments, the content profile 300 may be attached to a notification message received at block 410.

At block 430, a content status for content stored on the sharing party's device is updated. In several embodiments, this status update is triggered by receipt of the notification message. In others, the content status for the sharing party's device might be regularly updated, so that a current status is already available when the notification message is received. The content status may comprise an index of files stored on the sharing party's device, and may be organized by file type, subject matter, or other organization scheme. The content status may also comprise metadata associated with the files stored on the sharing party's device; this metadata may comprise information such as date created and/or modified, author's name or other identification, tags identifying subject matter or related topics, and so on. In other embodiments, a copy of some or all of the multimedia files stored on the sharing party's device may be stored at content server 170 or application server 125; thus, updating the content status may comprise synchronizing the server's copy of the device's contents. In these embodiments, the user of the communications device may be permitted to control which files are replicated at the server and which are not. For instance, in some embodiments, storing files in one or more specially designated folders may result in those files being replicated at the server, while storing files in other folders may result in those files being unavailable for sharing.

At block 440, content server 170 or application server 125 checks whether a prior content update has been sent to the receiving party. If so, the date when the prior content update and/or the contents of that prior content update may be used in determining which files should be considered in providing a new content update. Thus, at block 450, a content update is formed, based on the updated content status for the sharing party's device, the content profile 300 corresponding to the receiving party, and prior content updates sent to the receiving party, if any. The content update is sent to the receiving party at block 460.

As previously discussed, the content update may comprise one or more copies of files from the shared party's device, descriptions of one or more files, or both. In some embodiments, descriptions of files stored on the shared party's device may comprise pointers, e.g. URLs, for use by the receiving party in retrieving a copy of one or more files stored on the shared party's device. In some embodiments, those pointers will be directed to files stored on content server 170 or application server 125. In other embodiments, activation of a pointer by the receiving party may cause the server to retrieve a copy of the corresponding file from the shared party's device.

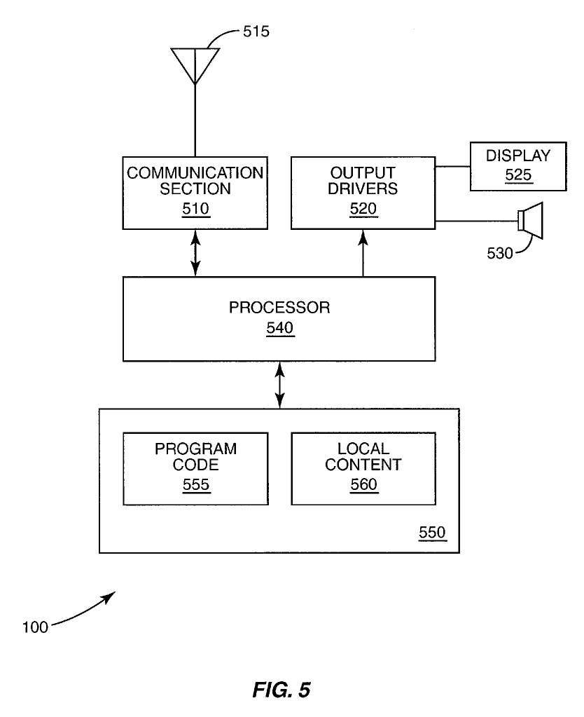

FIG. 5 illustrates an exemplary mobile terminal 100 configured to carry out one or more of the methods described above, or variants thereof. Those skilled in the art will recognize that other communication devices, such as network-enabled laptop computers, personal digital assistants (PDAs), and the like, may be configured in a similar manner. Mobile terminal 100 comprises a communication section 510 connected to antenna 515; output drivers 520 connected to display 525 and speaker 530; a processor 540; and memory 550. Processor 540 is responsible for the overall operational control of the mobile terminal 100 according to programs and instructions 555 stored in memory 550. Processor 540 may comprise one or more microprocessors, microcontrollers, hardware circuits, or a combination thereof. Memory 550 stores data, including locally stored multimedia content 560, as well as program code 555 needed for operation of mobile terminal 100. Programs stored in memory 550 may include, for example, an operating system program and one or more application programs, including a media player application configured to produce audio and/or video signals for output drivers 520 from stored or streamed multimedia data. Local content 560 may comprise multimedia files, such as digital images, video files, music files, and the like, and may also comprise one or more content profiles 300 corresponding to friends, colleagues, etc. In some embodiments, content profiles 300 are integrated into or linked to a contacts database stored in memory 550. Memory 550 may comprise one or more discrete memory devices, including read-only memory devices, random access memory, flash memory, etc. Memory 550 may further include optical or magnetic storage devices.

Communication section 510 may comprise any known type of wireless transceiver to enable communication with other devices. Communication section 510 may comprise, for example, a cellular transceiver operating according to conventional cellular standards, such as GSM and WCDMA, a WiFi transceiver operating according to the 802.11 family of standards, a WiMAX transceiver, or a Bluetooth transceiver. Mobile terminal 100 may have multiple transceivers, each operating according to a different communication standard.

The output section of mobile terminal 100 comprises output drivers 520, one or more speakers 530, and one or more video displays 525. Output drivers 520 provide audio and video signals to the speaker 530 and video display 525, respectively. During a communication session with one or more remote terminals, audio, video, and/or text information is received by communication section 510, processed by processor 540, and routed to output drivers 520 for output to speaker 530 and display 525.

Processor 540 is configured for sharing local content 560, i.e. files stored in memory 550, with remote participants in a communications session. In particular, processor 540 is configured to detect the initiation of a communications session between mobile terminal 100 and a remote party/device, to form a content update based on local content 560, including an applicable content profile 300, and to send the content update to the remote party/device. In some embodiments, processor 540 is further configured to retrieve the content profile 300 from a content server 170 or application server 125, rather than from memory 550.

In some embodiments, processor 540 is further configured to check whether one or more prior content updates have been sent to the remote participant; if so, the content may be adapted, based on the prior content update or updates. Information regarding prior content updates is retrieved from memory 550 in some embodiments, and from a content server 170 or application server 125 in others.

In some embodiments, processor 540 is configured to send copies of one or more files stored in memory 550 to a content server 170 or application server 125, so that all or a portion of local content 560 is replicated on the server. In these embodiments, processor 540 may be configured to periodically update the server version of local content 560, or to keep all or part of local content 560 “synchronized” with the server version. Content updates sent by these embodiments may comprise pointers for use by a receiving party in retrieving a copy of a file from the server.

Memory 550 may further contain one or more user-defined settings that control the operation of processor 540 during or in response to communication sessions. For example, these settings may indicate that content updates should be sent only for certain types of communication sessions, or only to certain individuals or groups of individuals. These settings may indicate that only certain files or certain types should be shared.

Those skilled in the art will appreciate that the functional blocks described above for mobile terminal 100, although described with reference to a wireless mobile terminal, may be implemented in any of a variety of network-connected devices. Thus, other communications devices, such as Internet phones, network-enabled personal digital assistants, portable computers, and the like, may be configured as described to share multimedia content.

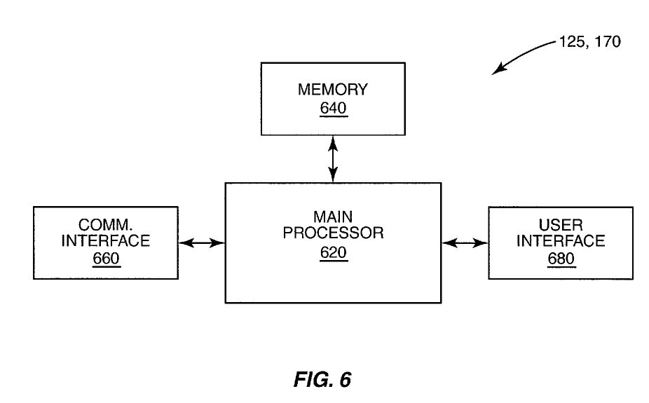

FIG. 6 illustrates an exemplary content server 170 or application server 125 that may be used in implementing some of the inventive methods described herein. Server 125, 170 comprises a processor 620, memory 640, and a communication interface 660. Processor 620 controls the operation of server 125, 170 and may comprise one or more microprocessors, microcontrollers, hardware circuits, or a combination thereof. Memory 640 stores applications executed by processor 620, and may store content profiles 300, prior content updates, and/or copies of local content for one or more sharing devices in some embodiments. Memory 640 may comprise one or more discrete memory devices, including read-only memory devices, random access memory, flash memory, etc. Memory 640 may further include mass storage devices, such as optical or magnetic storage devices. Stored applications may include operating system applications and/or server applications. Communication interface 660, such as an Ethernet interface, connects server 125, 170 to wireless communication network 120 or PDN 140, respectively. Server 125, 170 may further include a user interface 680 to enable maintenance by the operator of the server 125, 170.

While FIG. 6 illustrates an exemplary server 125, 170 residing at a single location, it should be understood that the functionality of server 125, 170 may be distributed among a plurality of locations.

In several embodiments, server 125, 170 is configured to receive notification of a communications session; to retrieve a content profile 300 for a first participant, using a user identifier included in or associated with the notification; to check for a prior content update sent to the first participant; to update content status for a second (sharing) participant; to form a content update, based on the content status, content profile, prior content updates (if any); and to send the content update to the first participant.

Those skilled in the art will appreciate that the present invention may be carried out in several other ways than those specifically set forth herein without departing from essential characteristics of the invention. Accordingly, the present embodiments should be considered in all respects as illustrative and not restrictive, and all changes coming within the meaning and equivalency range of the appended claims are intended to be embraced therein.

What is claimed is:

1. A method for sharing multimedia content in a communications network, comprising:
detecting the initiation of a communications session between a first communications device and a second communications device;
responsive to said initiation, forming a content update based on content stored on the first communications device;
sending the content update to the second communications device.

2. The method of claim 1, wherein detecting the initiation of a communications session comprises receiving, at a server, a message indicating the initiation of the communications session.

3. The method of claim 1, wherein forming the content update is further based on a prior content update previously sent to the second communications device.

4. The method of claim 1, further comprising retrieving a content profile corresponding to a user of the second communications device, and wherein forming the content update is further based on the content profile.

5. The method of claim 4, wherein retrieving a content profile corresponding to a user of the second communications device comprises requesting the content profile from a remote server, using an identifier corresponding to the user.

6. The method of claim 4, wherein retrieving a content profile corresponding to a user of the second communications device comprises requesting the content profile from the second communications and receiving the content profile in response.

7. The method of claim 4, wherein the content profile comprises a content type, and wherein forming the content update comprises forming the content update using one or more files stored on the first communications device and corresponding to the content type.

8. The method of claim 1, further comprising determining location data corresponding to the second communications device, and wherein forming the content update is further based on the location data.

9. The method of claim 1, further comprising determining an operational mode for the second communications device, and wherein forming the content update is further based on the operational mode.

10. The method of claim 1, wherein forming the content update comprises assembling the content update using one or more files stored on the first communications device.

11. The method of claim 1, wherein forming the content update comprises forming a content update describing one or more files stored on the first communications device.

12. The method of claim 11, wherein the content update comprises pointers corresponding to the one or more files for use by the second communications device in retrieving one or more of the files.

13. The method of claim 11, wherein the content update comprises pointers corresponding to copies of one or more files stored on the first communications device, the copies stored on a server, wherein the pointers are for use by the second communications device in retrieving one or more of the copies.

14. A communications device, comprising:
a communications section configured to communicate with a remote device;
a memory device configured to store multimedia content; and
a processor configured to:
detect the initiation of a communications session between the communications device and the remote device;
form a content update based on the multimedia content; and
send the content update to the remote device, using the communications section.

15. The communications device of claim 14, wherein the processor is further configured to form the content update based on a prior content update previously sent to the remote device.

16. The communications device of claim 14, wherein the processor is further configured to retrieve a content profile corresponding to a user of the remote device and to form the content update based on the content profile.

17. A server for use in a communications network, the server configured to:
receive a notification of a communication session between a first participant and a second participant, the notification comprising a first user identifier corresponding to the first participant;
retrieve a content profile for the first participant, using the first user identifier;
update a content status for a communications device associated with the second participant;
form a content update, based on the content status and the content profile; and
send the content update to the first participant.

18. The server of claim 17, wherein the server is configured to form the content update based on a prior content update previously sent to the first participant.

19. The server of claim 17, wherein the server is further configured to store copies of one or more files stored on the communications device, and wherein the content update comprises one or more pointers to the stored copies.

20. The server of claim 19, wherein the content profile comprises a content type, and wherein forming the content update comprises forming the content update using one or more of the copies corresponding to the content type.
